(19) United States
(12) Patent Application Publication
(10) Pub. No.: US 2005/0190725 A1
(43) Pub. Date: Sep. 1, 2005

(54) Diversity reception method and diversity receiver

(76) Inventors: Toshiyuki Wakisaka, Iizuka (JP); Shouichi Koga, Iizuka (JP); Michinori Kishimoto, Iizuka (JP); Masami Wada, Yokohama (JP)

Correspondence Address: WENDEROTH, LIND & PONACK, L.L.P., 2033 K STREET N. W., SUITE 800, WASHINGTON, DC, 20006-1021, US

(21) Appl. No.: 10/675,981

(22) Filed: Oct. 2, 2003

(30) Foreign Application Priority Data
Oct. 4, 2002 (JP) 2002-292465

(51) Int. Cl. H04Q 7/00

(52) U.S. Cl. 370/334; 375/343

(57) ABSTRACT

Reception level frequency distribution is determined. A frequency correlation bandwidth is determined in accordance with intervals between peaks or dips, or alternatively intervals between intersections wherein the reception level frequency distribution intersects a threshold. At the time of reception start, a training mode period is set up to determine a frequency correlation bandwidth. After the training mode period, signals are received in accordance with the determined frequency correlation bandwidth. The frequency correlation bandwidth is determined with increased precision to avoid a large amount of calculation such as Fourier transform. As a result, the entire diversity reception processing requires a reduced amount of calculation.

### BACKGROUND OF THE INVENTION

1. Field of the Invention

The present invention relates to an art of simply approximating a frequency correlation bandwidth, and a diversity reception method and diversity receiver for receiving a multi-carrier system-based signal and alleviating the influence of frequency selection-caused phasing using sub-band decomposition antenna diversity in order to provide improved communication performance.

2. Description of the Related Art

In nowadays high-speed transmission of information, attention has been focused on a multi-carrier system operable to carry the information at high speeds. The multi-carrier system divides the information into several sub-carriers, and transmits the sub-carriers in parallel therewith on a frequency axis. As a result, the multi-carrier system provides the high-speed transmission of information. At the same time, the high-speed information transmission requires a broad frequency bandwidth.

A multi-path causing circumstance brings about phasing that is responsible for degradation in communication quality.

In particular, a broadband multi-carrier system suffers from the influence of frequency selection-caused phasing that extremely reduces several reception levels within a frequency bandwidth.

In order to overcome such a problem, it has heretofore been proposed to use one diversity receiver (Example No. 1) as illustrated in FIG. 14 and another (Example No. 2) as illustrated in FIG. 15. The former diversity receiver employs per sub-carrier diversity, while the latter diversity receiver uses sub-band decomposition diversity.

The per sub-carrier diversity in Example No. 1 compares reception levels of received signals with each other for each sub-carrier, thereby practicing diversity.

The following provides a specific description of Example No. 1. The diversity receiver as illustrated in FIG. 14 includes antennas 1, 2, which are followed in sequence by time-frequency transforming units 3, 4, respectively.

The time-frequency transforming units 3, 4 transform information of respective signals received by the antennas 1, 2 into respective frequency regions. The time-frequency transforming units 3, 4 demodulate secondary modulation such as OFDM (orthogonal frequency division multiplex). The demodulated secondary modulation reveals the amplitude and phase of each of the reception levels.

Level-detecting units 6, 7 detect the respective reception levels at the antennas 1, 2.

A reception level-comparing unit 8 compares the reception levels detected by the level-detecting units 6, 7 with one another for each of the sub-carriers.

In accordance with results from the comparison using the reception level-comparing unit 8, a selecting unit 5 selects one of the antennas, which has a greater reception level.

A demodulating unit 9 demodulates the primary modulation of signals (such as QAM (quadrature amplitude modulation), QPSK (quadriphase shift keying), and BPSK (binary phase shift keing)) through a line of the antenna selected by the selecting unit 5.

The sub-band decomposition diversity in Example No. 2 divides a received signal into several sub-bands on the frequency axis to compare reception levels with each other for each of the sub-bands, thereby practicing diversity.

The following provides a specific description of Example No. 2. The diversity receiver as illustrated in FIG. 15 includes components given below, in which the same reference characters are given for components similar to those of FIG. 14, and descriptions related thereto are omitted.

Time-frequency transforming units 3, 4 are followed in sequence by sub-band decomposing units 10, 11, respectively. The sub-band decomposing units 10, 11 divide frequency regions into sub-bands in accordance with a predetermined sub-band decomposition width.

A reception level-comparing unit 8 compares reception levels detected by level-detecting units 6, 7 with one another for each of the sub-bands.

The sub-band decomposition width employed by the sub-band decomposition diversity must be a width having an increased frequency correlation in order to provide sufficient diversity effectiveness. A frequency correlation bandwidth is one of parameters to show such an increased frequency correlation width. The frequency correlation bandwidth is a frequency width equal or greater than frequency correlation “0.5”.

The frequency correlation bandwidth has heretofore been determined using two different methods. More specifically, it can be determined from delay spread, and alternatively, it can be calculated by a frequency correlation directly determined for each frequency.

In order to determine the frequency correlation bandwidth from the delay spread, a delay profile is initially determined. The delay spread is determined from the initial determination results in accordance with a formula given below. The delay profile is determined from two different methods. More specifically, a delay profile as illustrated in FIG. 16 (b) is determined using an impulse response as illustrated in FIG. 16 (a). Alternatively, a reception spectrum (a received signal having a frequency swept by a transmitter when the signal is transmitted from the transmitter) as illustrated in FIG. 17 (a) is transformed into a delay profile in accordance with Fourier transform.

[FORMULA 1]

When the delay profile is shaped as an ordinary exponential function as illustrated in FIG. 18, then the frequency correlation bandwidth can be determined in accordance with the following formula:

[FORMULA 2]

In order to calculate the frequency correlation bandwidth in accordance with a frequency correlation directly determined on a frequency-by-frequency basis, an intensity waveform of a received signal is measured as illustrated in FIG. 19, thereby determining a reference frequency and a correlation coefficient for each of the frequencies. As illustrated in FIG. 20, a frequency width having correlation coefficient “0.5” is determined as a correlation bandwidth.

However, examples Nos. 1 and 2 as discussed above have problems as given below.

Example No. 1 compares the reception levels with each other for each of the sub-carriers, and consequently provides high-operative diversity. At the same time, the comparison must be made for all of the sub-carriers. This disadvantage results in a huge amount of calculation and thus increased loads on system resources.

Example No. 2 divides a frequency band into several sub-bands, in which each of the sub-bands includes several sub-carriers. This means that several sub-carriers can be united together to practice the diversity. As a result, Example No. 2 is smaller in calculation amount than Example No. 1.

However, a non-high frequency correlation within the sub-band decomposition width reduces the effectiveness of the diversity. Accordingly, in order to retain increased effectiveness of the diversity in a state of a reduced calculation amount, the signal must be divided into sub-bands in accordance with a width having an increased frequency correlation.

The width having such an increased frequency correlation can be determined in accordance with the frequency correlation bandwidth. As discussed above, the frequency correlation bandwidth is determined either from the delay profile or from the frequency correlation directly determined for each frequency.

In determining the frequency correlation bandwidth from the delay profile, the impulse response must be measured to calculate the delay profile, or otherwise the reception spectrum in receipt of a transmitted and swept signal must be measured to transform results from the measurement into the delay profile in accordance with Fourier transform. Moreover, the delay spread must be determined from the delay profile to determine the frequency correlation bandwidth from the former determination results. These steps require a complicated receiver structure, with the result of an enormous amount of calculation. This is difficult to achieve.

In determining the frequency correlation bandwidth from the frequency correlation directly determined for each of the frequencies, distribution defined by received signal intensity and reception locations must be determined. This means that the diversity receiver must be moved. This is an impractical manner.

### OBJECTS AND SUMMARY OF THE INVENTION

In view of the above, an object of the present invention is to provide an art of determining a frequency correlation bandwidth in an easier and more practical manner using the frequency correlation bandwidth as a frequency width having an increased frequency correlation, without determining a delay profile from an impulse response and without transforming frequency distribution in receipt of a transmitted and swept frequency into the delay profile in accordance with Fourier transform.

A first aspect of the present invention provides a diversity reception method comprising: determining a frequency correlation bandwidth in accordance with reception level frequency distribution.

This method eliminates Fourier transform in contrast with a method for determining a frequency correlation bandwidth from the delay profile. This feature provides a considerably reduced amount of calculation required to determine the frequency correlation bandwidth.

In addition, the above method eliminates the movement of a diversity receiver in contrast with a method for directly determining a frequency correlation for each frequency. This feature provides high feasibility.

Furthermore, the Inventor's study reveals that the frequency correlation bandwidth determined with ease as previously described is sufficient in precision.

In short, the diversity reception method according to the first aspect of the present invention makes it feasible to determine the frequency correlation bandwidth having sufficient precision through a less amount of calculation.

A second aspect of the present invention provides a diversity reception method comprising: receiving a multi-carrier system-based signal; dividing a frequency region into sub-bands in accordance with a frequency correlation bandwidth; comparing reception levels at antennas with each other for each of the sub-bands; selecting one of the antennas, which has a greater reception level than the other reception levels; and practicing diversity, wherein a training mode period is provided at the time of reception start to determine the frequency correlation bandwidth, and the signal is received after the training mode period in accordance with the frequency correlation bandwidth determined during the training mode period.

This method determines the frequency correlation bandwidth during the training mode period, and consequently retains diversity effectiveness, even after the training mode period. In addition, the above method is possible to process several sub-carriers in a body in accordance with the frequency correlation bandwidth after the training mode period. This feature considerably reduces the entire calculation amount.

A third aspect of the present invention provides a diversity reception method as defined in the second aspect of the present invention, wherein the frequency correlation bandwidth is a frequency width having a 0.5 or greater correlation coefficient.

This method allows a sub-band decomposition width to always provide a frequency correlation bandwidth having an increased frequency correlation. This feature maintains diversity effectiveness.

A fourth aspect of the present invention provides a diversity reception method as defined in the second aspect of the present invention, wherein the frequency correlation bandwidth is determined in accordance with intervals between peaks and/or between dips in reception level frequency distribution.

A fifth aspect of the present invention provides a diversity reception method as defined in the second aspect of the present invention, wherein the frequency correlation bandwidth is a half of each interval between peaks and/or between dips in reception level frequency distribution.

A sixth aspect of the present invention provides a diversity reception method as defined in the second aspect of the present invention, wherein the frequency correlation bandwidth is determined in accordance with intervals between intersections where reception level frequency distribution intersects a reception level threshold.

A seventh aspect of the present invention provides a diversity reception method as defined in the second aspect of the present invention, wherein the frequency correlation bandwidth is an either average or mean value of intervals between intersections where reception level frequency distribution intersects a reception level threshold.

The methods as previously discussed precisely approximate the frequency correlation bandwidth without diversity receiver movement and complicated, huge calculation. This feature provides sufficient diversity effectiveness in view of practical use.

An eight aspect of the present invention provides a diversity reception method as defined in the sixth aspect of the present invention, wherein the threshold is determined in accordance with a combination of one element or two or greater elements selected from among reception level average, mean, maximum or minimum values of all sub-carriers that form the signal.

This method appropriately establishes the threshold in accordance with an actual reception state.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a diversity receiver according to a first embodiment of the present invention;

FIG. 2 is a descriptive illustration showing how a frequency correlation bandwidth is approximated according to the first embodiment;

FIG. 3 is a descriptive illustrating showing how the diversity receiver is operated during a training mode period according to the first embodiment;

FIG. 4 is a descriptive illustrating showing how the diversity receiver is operated after the training mode period according to the first embodiment;

FIG. 5 is a graph illustrating time-based variations in calculation amount of the diversity receiver according to the first embodiment;

FIG. 6 is an illustration showing an example of reception level frequency distribution according to the first embodiment;

FIG. 7 is a block diagram illustrating a diversity receiver according to a second embodiment;

FIG. 8 is a descriptive illustration showing how a frequency correlation bandwidth is approximated according the second embodiment;

FIG. 9 is a descriptive illustrating showing how the diversity receiver is operated during a training mode period according to the second embodiment;

FIG. 10 is an illustration showing an example of reception level frequency distribution according to the second embodiment;

FIG. 11 is a block diagram illustrating a diversity receiver according to a third embodiment;

FIG. 12 is a descriptive illustration showing how a frequency correlation bandwidth is approximated according the third embodiment;

FIG. 13 is a descriptive illustrating showing how the diversity receiver is operated during a training mode period according to the third embodiment;

FIG. 14 is a block diagram illustrating a prior art diversity receiver as a first example;

FIG. 15 is a block diagram illustrating a prior art diversity receiver as a second example;

FIG. 16(a) is a graph illustrating an input impulse as a study case;

FIG. 16(b) is an illustration showing an example of a delay profile as a study case;

FIG. 17(a) is an illustration showing an example of results from measurement as a study case;

FIG. 17(b) is an illustration showing an example of a delay profile as a study case;

FIG. 18 is an illustration showing an example of a delay profile as a study case;

FIG. 19 is an illustration showing an example of reception level positional distribution; and

FIG. 20 is a graph illustrating a relationship between a correlation coefficient and a frequency interval as a study case.

### DETAILED DESCRIPTION OF THE PREFERRED EMBODIMENTS

Embodiments of the present invention are described with reference to the accompanying drawings.

### First Embodiment

During a training mode period, a first embodiment includes the steps of transforming a signal received by an antenna into a frequency region, determining intervals between frequency selection-caused phasing dip points (dips), approximating a frequency correlation bandwidth in accordance with the determined interval values, and determining a sub-band decomposition width.

After the training mode period, the first embodiment includes the steps of dividing a multi-carrier frequency band into sub-bands in accordance with the determined sub-band decomposition width, and practicing diversity for each of the sub-bands.

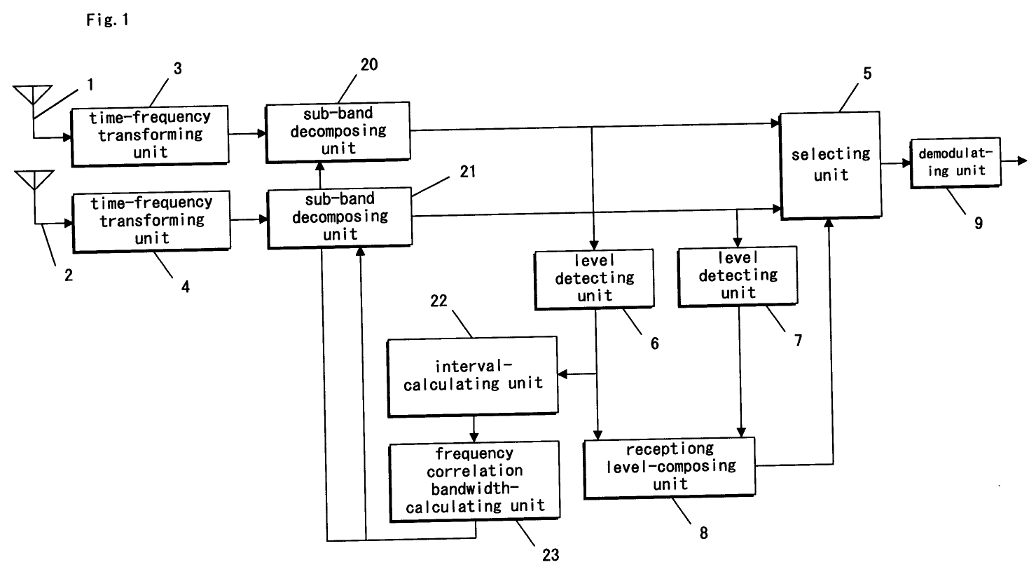

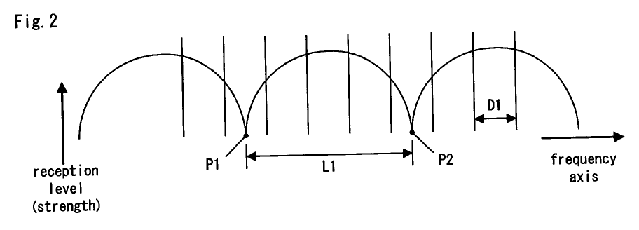

FIG. 1 is a block diagram illustrating a diversity receiver according to the first embodiment. FIG. 2 is a descriptive illustration showing how the frequency correlation bandwidth is approximated.

In FIG. 1, the same reference characters are provided for components similar to those used in the prior art, and descriptions related thereto are omitted.

In FIG. 1, an interval-calculating unit 22 in receipt of detection results from a level-detecting unit 6 determines reception level frequency distribution as illustrated in FIG. 2.

The interval-calculating unit 22 calculates intervals between reception level dips (phasing dips) in the distribution. In FIG. 2, the interval-calculating unit 22 determines spacing “L1” between dips “P1” and “P2”.

A frequency correlation bandwidth-calculating unit 23 determines a sub-band decomposition width in accordance with information that derives from reception levels detected by the level-detecting units 6, 7.

More specifically, the frequency correlation bandwidth-calculating unit 23 in receipt of the dip intervals (spacing “L1” in FIG. 2) from the interval-calculating unit 22 approximates spacing “D1” as a frequency correlation bandwidth. Spacing “D1” is a positive value equal or smaller than a half of spacing “L1”.

The following discusses the reason why the frequency correlation bandwidth is defined as the positive value equal or smaller than a half of each of the dip intervals. When a signal having a waveform as illustrated in FIG. 6 is received, then a frequency correlation bandwidth calculated from a delay profile is some 13 MHz. The above system according to the present embodiment determines a half of each mean value of the intervals between the dips, thereby providing 12.7 MHz, which is substantially equal to the frequency correlation bandwidth determined from the delay profile.

The following discusses, with reference to FIG. 2, how the diversity receiver according to the present embodiment is operated during the training mode period.

The antennas 1, 2 receive signals. The time-frequency transforming unit 3, 4 demodulate the secondary modulation of the received signals, thereby transforming the signals into frequency regions.

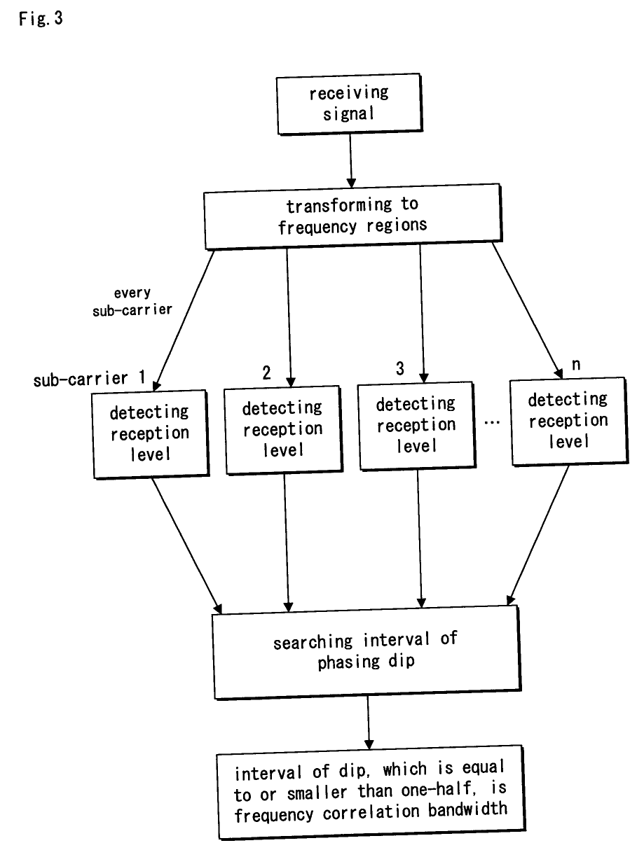

The level-detecting unit 6 detects a reception level for each sub-carrier, and then feeds results from the detection into the interval-calculating unit 22. As illustrated in FIG. 3, “n”-number of sub-carriers is present.

The interval-calculating unit 22 determines the intervals between the dips, as previously discussed, and then feeds the determined intervals into the frequency correlation bandwidth-calculating unit 23.

The frequency correlation bandwidth-calculating unit 23 multiplies each of the entered dip intervals by a positive coefficient equal or smaller than a half, thereby determining a frequency correlation bandwidth as a sub-band decomposition width. The determined frequency correlation bandwidth is sent to sub-band decomposing units 20, 21.

In this way, the present embodiment allows simple calculation to precisely approximate the frequency correlation bandwidth. In addition, the present embodiment determines the sub-band decomposition width having an increased frequency correlation and reflecting an actual reception state. Pursuant to the present embodiment, the sub-band decomposition width is set to be equal to the frequency correlation bandwidth; however, the present embodiment is not limited thereto.

The above description refers to only the reception level dips. Alternatively, peaks may be used.

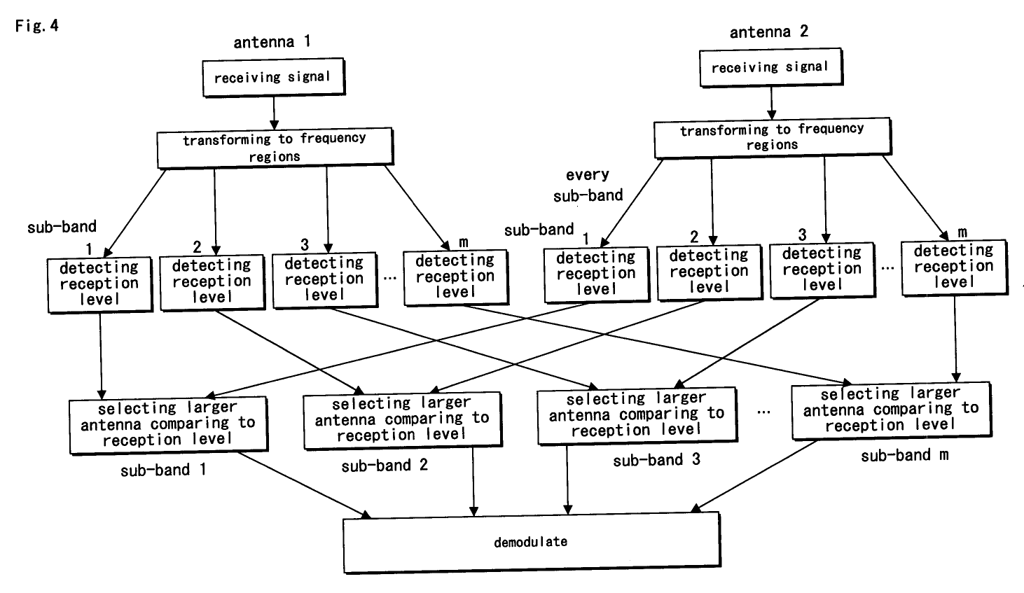

The following discusses, with reference to FIG. 4, how the diversity receiver according to the present embodiment is operated after the training mode period.

The antennas 1, 2 receive signals. The time-frequency transforming unit 3, 4 demodulate the secondary modulation of the received signals, thereby transforming the signals into frequency regions.

The sub-band decomposing units 20, 21 output and collect the output from the time-frequency transforming units 3, 4 for each sub-band. At this time, the sub-band decomposing units 20, 21 use the sub-band decomposition widths that are set up during the training mode period, as described above.

The level-detecting units 6, 7 detect a reception level for each of the sub-bands, and then feeds results from the detection into the reception level-comparing unit 8. The reception level-comparing unit 8 determines a line of an antenna having a greater reception level (a line of the antenna either 1 or 2 according to the present embodiment) for each of the sub-bands. The reception level-comparing unit 8 instructs the selecting unit 5 to select the determined line. As a result, a signal related to an antenna having a higher reception level for each of the sub-bands is fed into the demodulating unit 9, thereby demodulating the signal.

Each of the sub-bands has several sub-carriers collected therein. As illustrated in FIG. 4, “m”-number of sub-bands is present, in which “m” is smaller than “n” (m<n). Accordingly, the reception level-detecting unit 8 is only required to compare the “m”-number of sub-bands with each other, in which number “m” is considerably smaller than number “n”. The step of dividing the sub-carriers in accordance with the sub-bands provides a considerably reduced amount of calculation, when compared with comparison processing for each of the sub-carriers.

In addition, high correlation within the sub-bands is maintained while the calculation amount is reduced. As a result, sufficient diversity effectiveness is achievable.

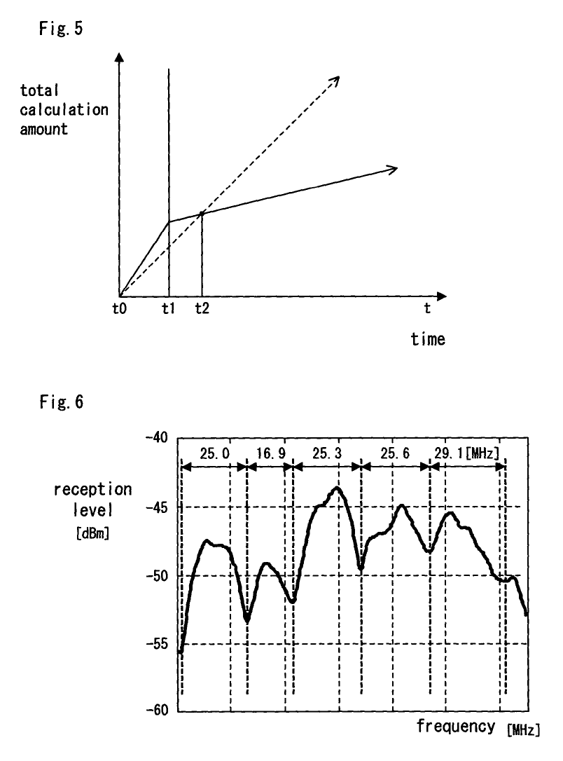

FIG. 5 is a graph illustrating time-based variations of the calculation amount provided by the diversity receiver according to the present embodiment. In FIG. 5, a solid line shows an amount of calculation made by the diversity receiver according to the present embodiment, while a dotted line illustrates an amount of calculation according to the diversity practiced for each of the sub-carriers.

As seen from FIG. 5, during the training mode period between time “t0” to “t1”, the amount of calculation made by the diversity receiver according to the present embodiment exceeds that according to the per sub-carrier diversity. However, this is not a long period.

After the training mode period, the diversity receiver according to the present embodiment starts processing on a per sub-band basis, and consequently provides a reduced amount of calculation per unit of time. At turnout point time “t2”, the calculation amount according to the present embodiment intersects the calculation amount according to the diversity practiced for each of the sub-carriers. Thereafter, communication becomes active. It is understood that during such a period of active communication, the amount of calculation made by the diversity receiver according to the present embodiment remains smaller than that according to the diversity practiced for each of the sub-carriers.

### Second Embodiment

A second embodiment includes the steps of transforming a signal received by an antenna into a frequency region, comparing a result from the transformation with a threshold to determine whether or not the result is greater than the threshold, determining a frequency interval greater than the threshold, approximating a frequency correlation bandwidth in accordance with the determined frequency interval value, and determining a sub-band decomposition width. The following discusses only differences between the present embodiment and the previous embodiment.

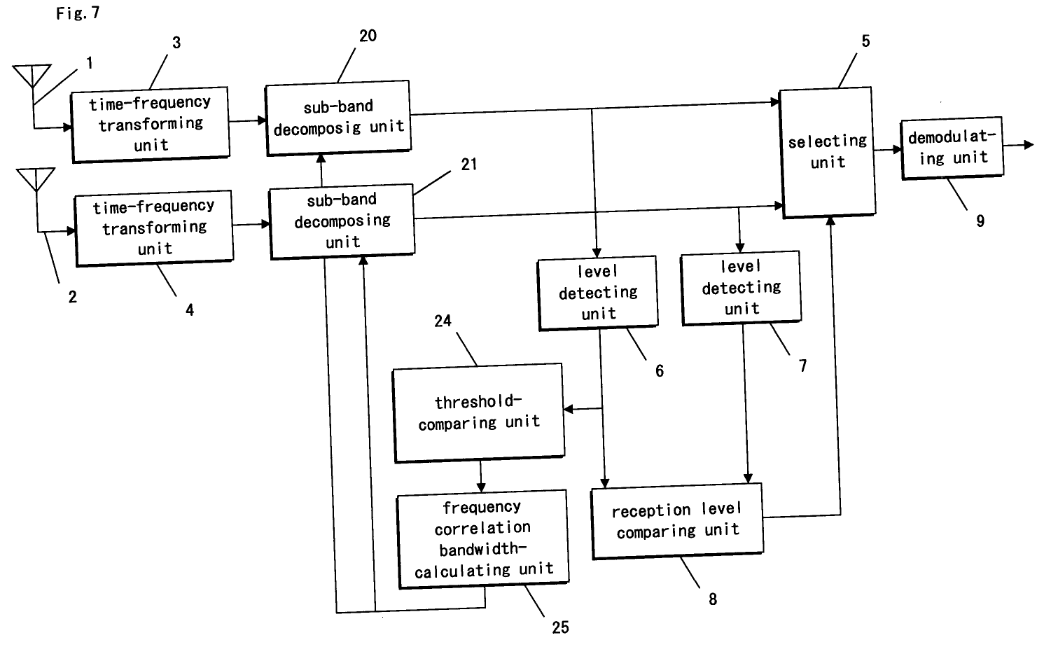

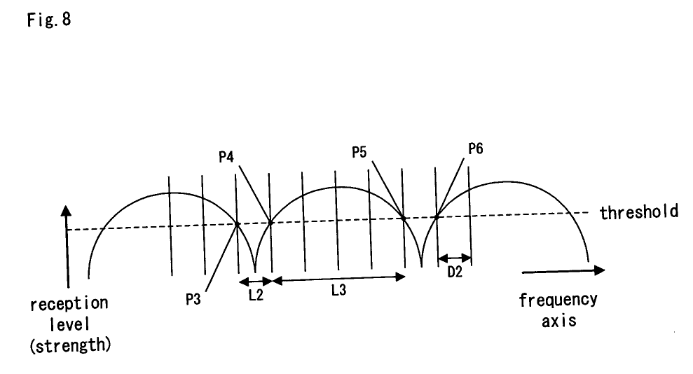

FIG. 7 is a block diagram illustrating a diversity receiver according to the present embodiment. FIG. 8 is a descriptive illustration showing how the frequency correlation bandwidth is approximated.

In FIG. 7, the same reference characters are given for components similar to those described in FIG. 1; therefore, descriptions related thereto are omitted.

In FIG. 7, a threshold-comparing unit 24 calculates intervals between intersections where reception level frequency distribution intersects a reception level threshold.

The threshold is determined in accordance with a combination of one element or two or greater elements selected from among reception level average, mean, maximum, or minimum values for all sub-carriers.

The threshold-comparing unit 24 in receipt of detection results from the level-detecting unit 6 determines the reception level frequency distribution as illustrated in FIG. 8.

The threshold-comparing unit 24 calculates the intervals between the intersections as previously discussed. In FIG. 8, spacing “L2” between intersections “P3” and “P4” and spacing “L3” between intersections “P4” and “P5” are determined.

A frequency correlation bandwidth-calculating unit 25 determines a sub-band decomposition width in accordance with the intersectional intervals calculated by the threshold-comparing unit 24.

More specifically, the frequency correlation bandwidth-calculating unit 25 approximates interval “D2” as a frequency correlation bandwidth. Interval “D2” is a positive value equal or smaller than frequency interval “L3” that exceeds a threshold.

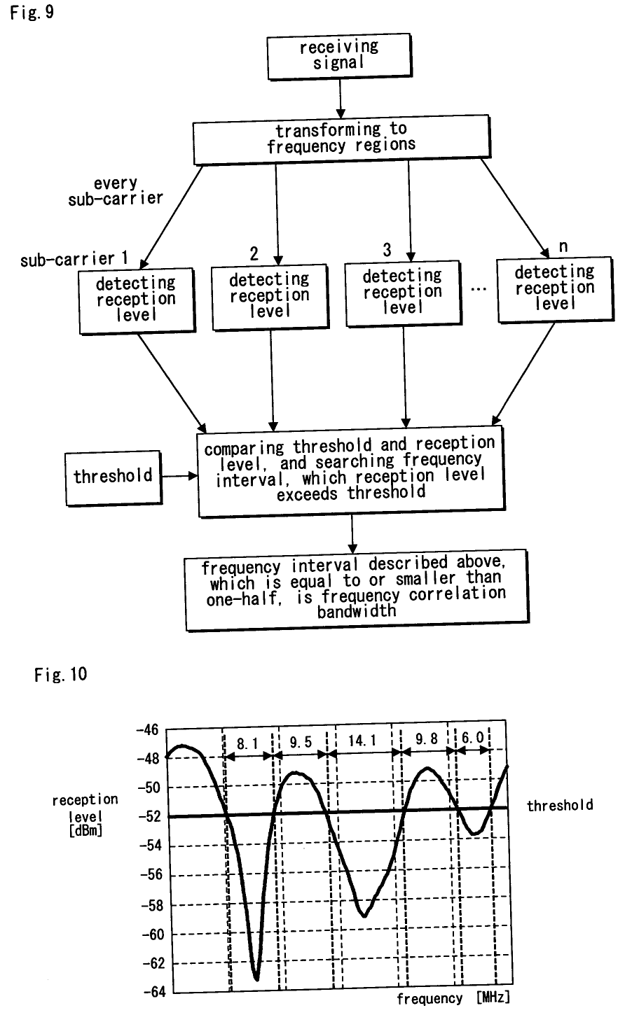

The following discusses the reason why the frequency correlation bandwidth is set to be a positive value equal or smaller than interval “D2”. When a signal having a waveform as illustrated in FIG. 10 is received, then a frequency correlation bandwidth calculated from a delay profile is some 10 MHz. The above system according to the present embodiment calculates a mean value of each of the intervals between the intersections where the reception level frequency distribution intersects the reception level threshold (mean value), thereby providing some 9.5 MHz, which is substantially equal to the frequency correlation bandwidth determined from the delay profile.

The following discusses, with reference to FIG. 9, how the diversity receiver according to the present embodiment is operated during the training mode period.

Antennas 1, 2 receive signals. A time-frequency transforming unit 3, 4 demodulates the secondary modulation of the received signals, thereby transforming the signals into frequency regions.

The level-detecting unit 6 detects a reception level for each sub-carrier, and then feeds results from the detection into the threshold-comparing unit 24. As illustrated in FIG. 9, “n”-number of sub-carriers is present.

The threshold-comparing unit 24 determines interval “L3” between the intersections as previously discussed, and then feeds the determined interval “L3” into the frequency correlation bandwidth-calculating unit 25.

The frequency correlation bandwidth-calculating unit 25 multiplies the entered interval “L3” by a positive coefficient equal or smaller than “1”, thereby determining a frequency correlation bandwidth as a sub-band decomposition width. The determined frequency correlation bandwidth is sent to sub-band decomposing units 20, 21.

In conclusion, the present embodiment allows simple calculation to approximate the frequency correlation bandwidth. In addition, the present embodiment determines the sub-band decomposition width having an increased frequency correlation and reflecting an actual reception status.

Descriptions related to a post-training mode period are omitted because the descriptions are similar to those according to the previous embodiment.

### Third Embodiment

A third embodiment includes the steps of transforming signals received by several antennas into frequency regions, comparing reception levels at the antennas with each other to determine whether or not one of the reception levels is greater than the others, determining one frequency width in which the reception level at one of the antennas is increased, and another frequency width in which the reception level at one of the antenna is decreased, calculating a width having an increased frequency correlation in accordance with the determined frequency width value, and determining a sub-band decomposition width. The following discusses only differences between the first embodiment and the present embodiment.

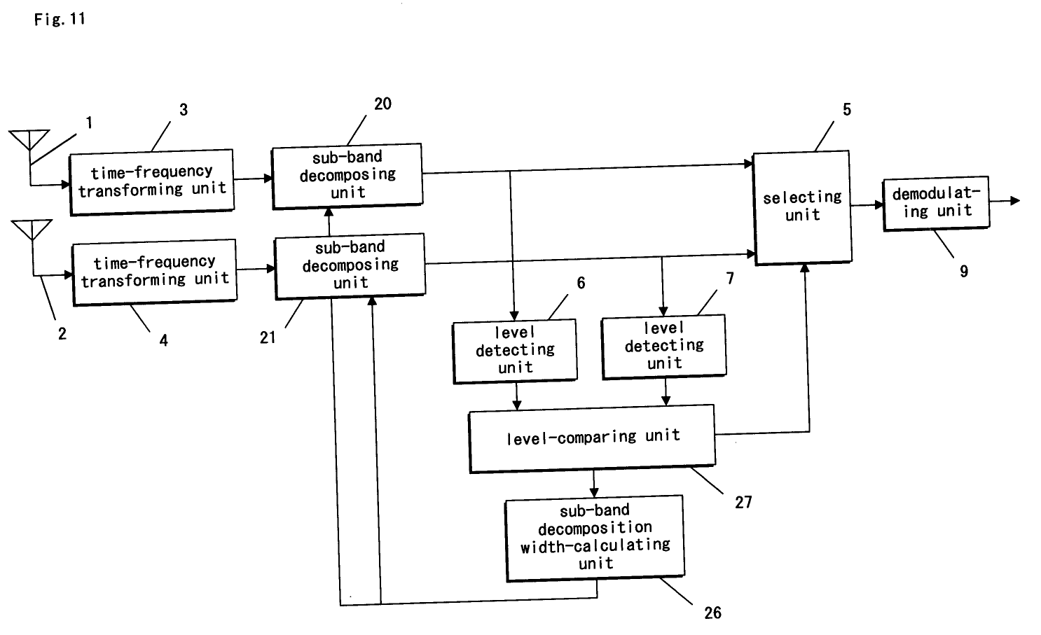

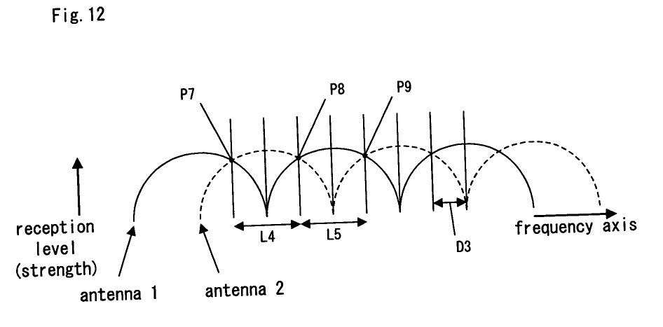

FIG. 11 is a block diagram illustrating a diversity receiver according to the present embodiment. FIG. 12 is a descriptive illustration showing how the sub-band decomposition width is set up.

In FIG. 11, the same reference characters are given for components similar to those designated in FIG. 1; therefore, descriptions related thereto are omitted.

In FIG. 11, a level-comparing unit 27 calculates intervals between intersections along reception level frequency distribution for the antennas 1, 2.

A sub-band decomposition width-calculating unit 26 determines a sub-band decomposition width in accordance with the intersectional intervals calculated by the level-comparing unit 27.

The level-comparing unit 27 in receipt of detection results from level-detecting units 6, 7 determine the reception level frequency distribution as illustrated in FIG. 10.

The level-comparing unit 27 calculates the intervals between the intersections at several reception levels in the distribution. In FIG. 12, interval “L4” between intersections “L7” and “L8”, and interval “L5” between intersections “P8” and “P9” are determined.

A sub-band decomposition width-calculating unit 26 determines a sub-band decomposition width in accordance with intervals “L4” and “L5” calculated by the level-comparing unit 27.

More specifically, the sub-band decomposition width-calculating unit 26 calculates a positive spacing equal or smaller than a half of, e.g., interval “L4” as sub-band decomposition width “D3”.

The following discusses the reason why sub-band decomposition width “D3” is set to be a positive spacing equal or smaller than a half of interval “L4”. As illustrated in FIG. 12, when the reception level at each of the antennas is an ideal frequency selection-caused phasing of a two-wave interference, and when one of the antennas complements a reduction in reception level at the other antennas, then a frequency correlation coefficient is “0.5” or greater in the range in which sub-band decomposition width “D3” is a positive spacing equal or smaller than a half of interval “L4”.

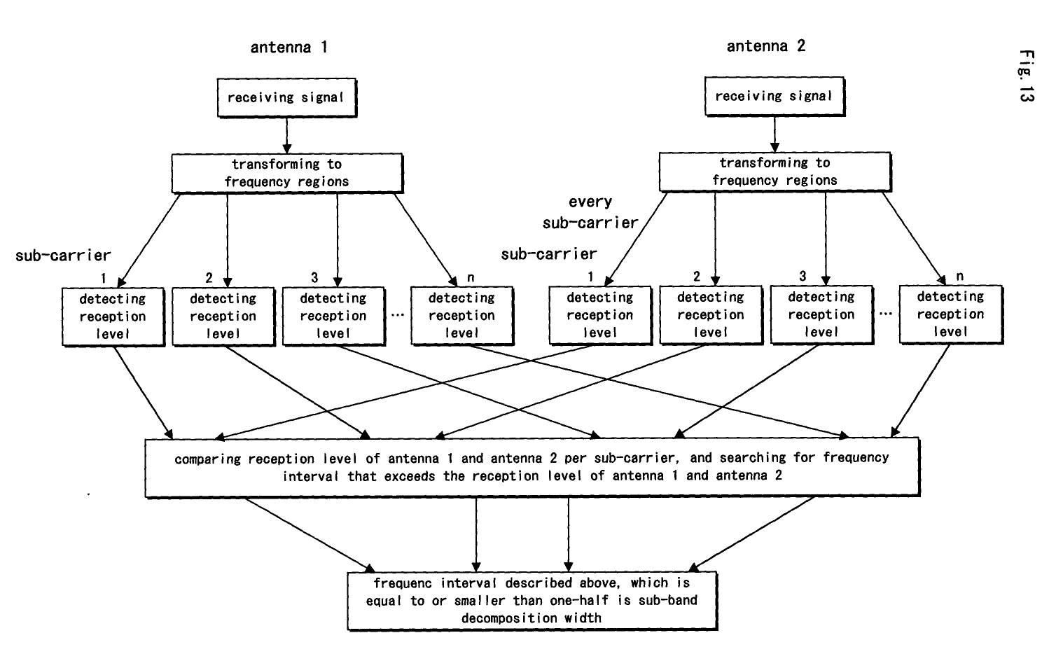

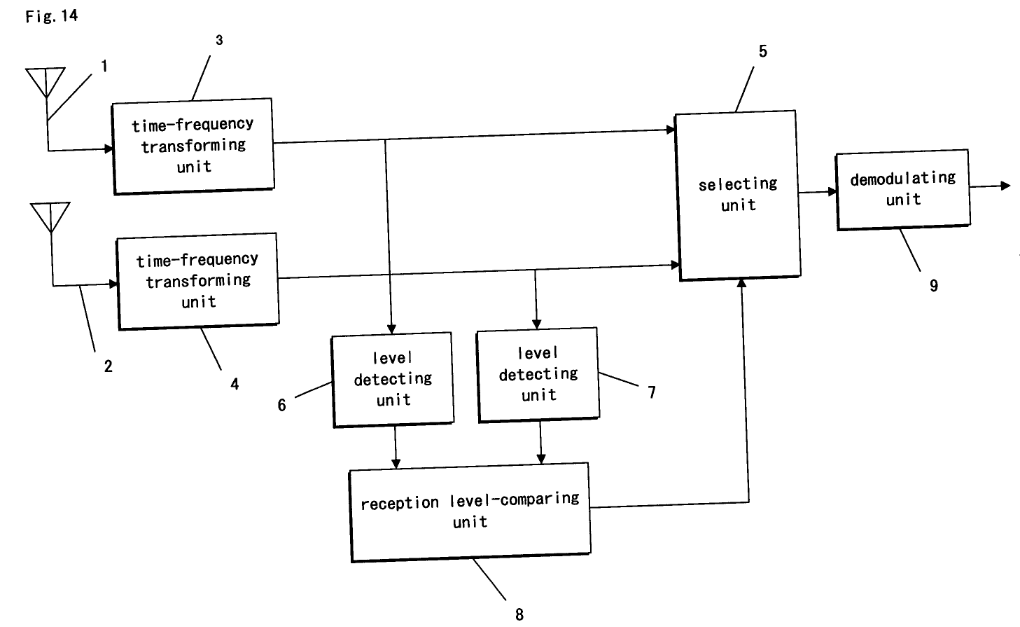

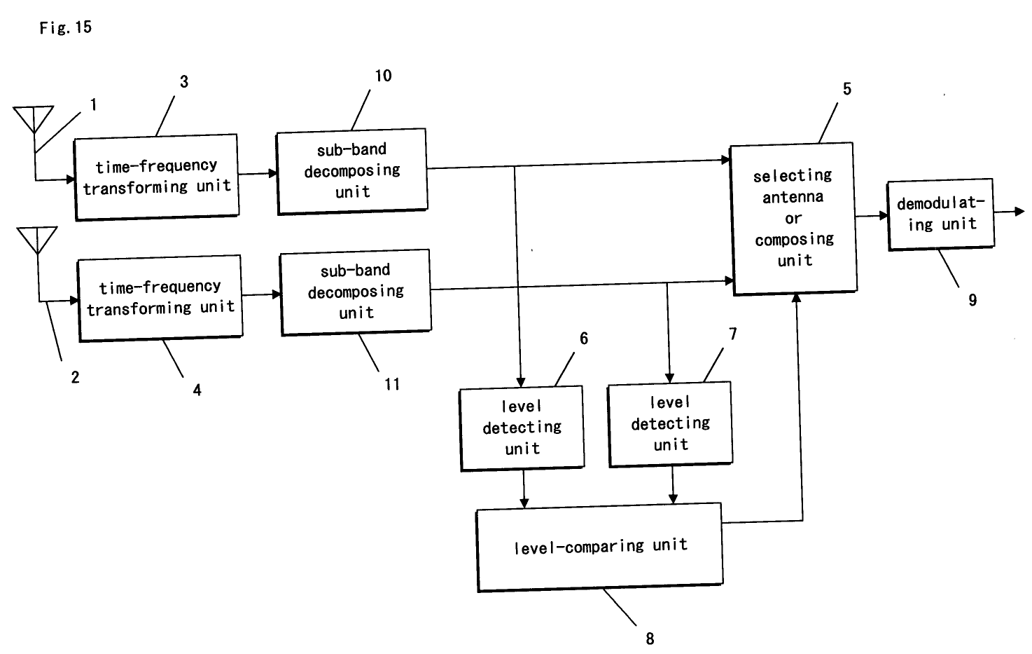

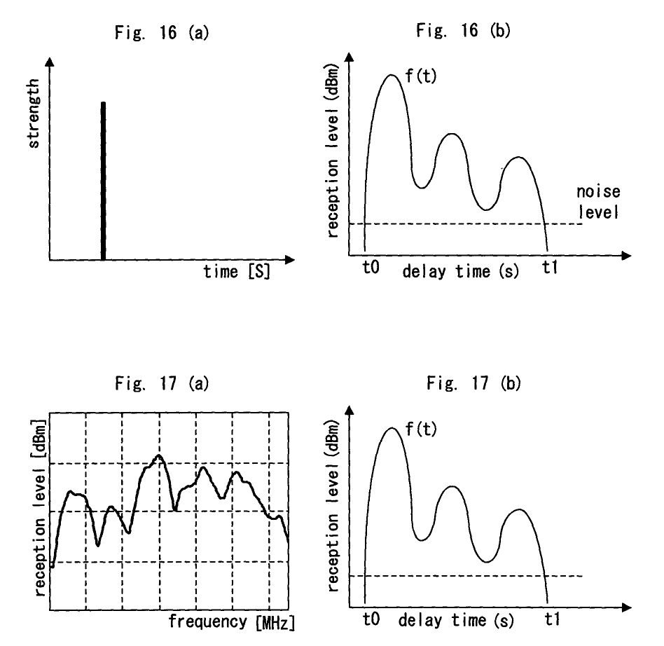

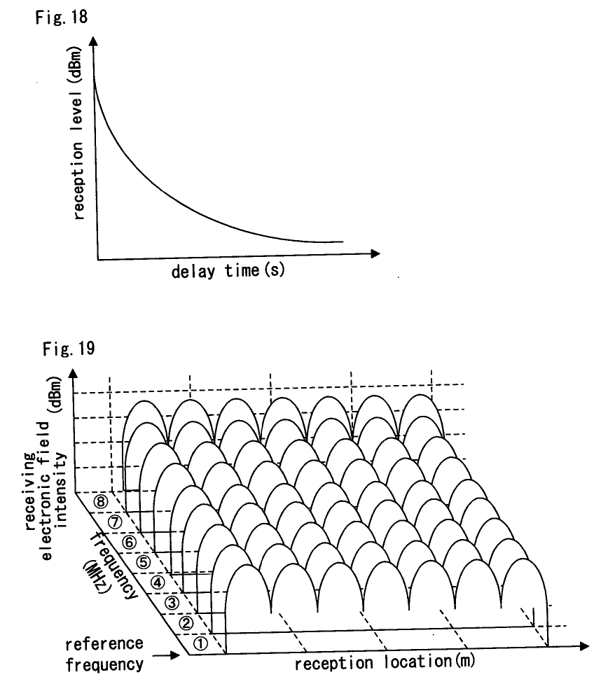

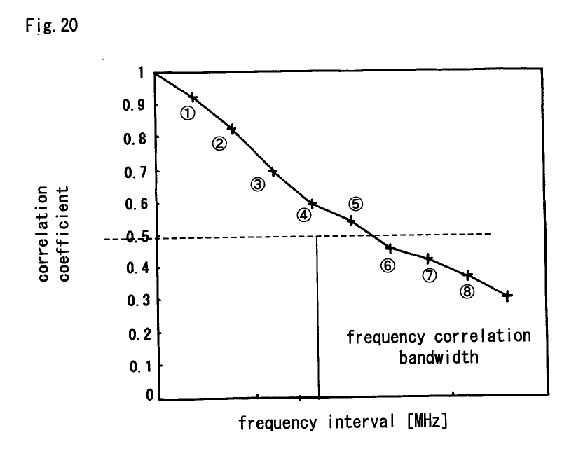

The following discusses, with reference to FIG. 13, how the diversity receiver according to the present embodiment is operated during a training mode period.

The antennas 1, 2 receive signals. A time-frequency transforming units 3, 4 demodulate the secondary modulation of the received signals, thereby transforming the signals into frequency regions.

The level-detecting units 6, 7detect reception levels at the antennas 1, 2 for each sub-carrier, and then feeds results from the detection into the level-comparing unit 27. In FIG. 13, number “n” of sub-carriers is present.

The level-comparing unit 27 determines interval “L4” between the intersections as previously discussed, and then feeds the determined interval “L4” into the sub-band decomposition width-calculating unit 26.

The sub-band decomposition width-calculating unit 26 multiplies the entered interval “L4” by a positive coefficient equal or smaller a quarter, thereby determining a sub-band decomposition width. The determined sub-band decomposition width is fed into sub-band decomposing units 20, 21.

In this way, the present embodiment allows simple calculation to approximate the frequency correlation bandwidth. In addition, the present embodiment determines the sub-band decomposition width having an increased frequency correlation and reflecting an actual reception status.

Descriptions related to a post-training mode period are omitted because the descriptions are similar to those according to the first embodiment.

In conclusion, the present invention provides beneficial effects given below. Initially, the frequency correlation bandwidth can simply be determined with a less amount of calculation than a prior art calculation amount; while the precision of the determined frequency correlation bandwidth is substantially equivalent to prior art precision. Furthermore, the determined frequency correlation bandwidth is used to determine a sub-band decomposition width of multi-carrier system sub-band decomposition diversity. This step provides diversity effectiveness substantially equivalent to that obtained by the diversity being practiced for each sub-carrier.

The calculation to determine the sub-band decomposition width is limited to the training mode period. As a result, when a turnout point time passes, then an amount of calculation is reduced than that necessary to conduct the diversity for each of the sub-carriers.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A sub-band decomposition diversity reception method comprising:
determining a frequency correlation bandwidth in accordance with reception level frequency distribution.

2. A sub-band decomposition diversity reception method comprising:
determining reception level frequency distribution; and
determining a frequency correlation bandwidth in accordance with intervals between peaks and/or between dips in the reception level frequency distribution.

3. A sub-band decomposition diversity reception method comprising:
determining reception level frequency distribution; and
determining a frequency correlation bandwidth in accordance with intervals between intersections where a reception level intersects a threshold in the reception level frequency distribution.

4. A diversity reception method comprising:
receiving a multi-carrier system-based signal;
dividing a frequency region into sub-bands in accordance with a frequency correlation bandwidth;
comparing reception levels at antennas with each other for each of the sub-bands;
selecting one of the antennas, which has a greater reception level than the other reception levels; and
practicing diversity,
wherein a training mode period is provided at time of reception start to determine the frequency correlation bandwidth, and
wherein the signal is received after the training mode period in accordance with the frequency correlation bandwidth determined during the training mode period.

5. A diversity reception method as defined in claim 4, wherein the frequency correlation bandwidth is determined in accordance with reception level frequency distribution.

6. A diversity reception method as defined in claim 4, wherein the frequency correlation bandwidth is a frequency width having a 0.5 or greater frequency correlation coefficient.

7. A diversity reception method as defined in claim 4, wherein the frequency correlation bandwidth is determined in accordance with intervals between peaks and/or between dips in reception level frequency distribution.

8. A diversity reception method as defined in claim 4, wherein the frequency correlation bandwidth is a half of each interval between peaks and/or between dips in reception level frequency distribution.

9. A diversity reception method as defined in claim 4, wherein the frequency correlation bandwidth is determined in accordance with intervals between intersections where reception level frequency distribution intersects a reception level threshold.

10. A diversity reception method as defined in claim 4, wherein the frequency correlation bandwidth is one of average and mean values of intervals between intersections where reception level frequency distribution intersects a reception level threshold.

11. A diversity reception method as defined in claim 9, wherein the threshold is determined in accordance with a combination of one element or two or greater elements selected from among reception level average, mean, maximum, and minimum values of all sub-carriers that form the signal.

12. A diversity receiver comprising:
several antennas;
a time-frequency transforming unit operable to transform information of a signal received by each of said antennas into a frequency region;
a level-detecting unit operable to detect a reception level of each of said antennas;
a frequency correlation bandwidth-calculating unit operable to determine a frequency correlation bandwidth in accordance with information that derives from the reception level detected by said level-detecting unit;
a sub-band decomposition-calculating unit operable to determine a sub-band decomposition bandwidth in accordance with the frequency correlation bandwidth determined by said frequency correlation bandwidth-calculating unit, and operable to divide the frequency region into sub-bands;
a reception level-comparing unit operable to compare the reception levels detected by said level-detecting units with each other for each of the sub-bands; and
a selecting unit operable to select one of said antennas, which has a greater reception level than the other reception levels, in accordance with results from the comparison made by said reception level-comparing unit.

13. A diversity receiver as defined in claim 12, further comprising:
an interval-calculating unit operable to calculate intervals between peaks and/or between dips in reception level frequency distribution,
wherein said frequency correlation bandwidth-calculating unit determines the frequency correlation bandwidth in accordance with the intervals calculated by said interval-calculating unit.

14. A diversity receiver as defined in claim 12, further comprising:
a threshold-comparing unit operable to calculate intervals between intersections where reception level frequency distribution intersects a reception level threshold,
wherein said frequency correlation bandwidth-calculating unit determines the frequency correlation bandwidth in accordance with the intervals calculated by said threshold-comparing unit.

15. A diversity receiver as defined in claim 14, wherein the threshold is determined in accordance with a combination of one element or two or greater elements selected from among reception level average, mean, maximum, and minimum values of all sub-carriers that form the signal.
